(19) United States
(12) Patent Application Publication
(10) Pub. No.: US 2014/0084888 A1
(43) Pub. Date: Mar. 27, 2014

(54) POWER SUPPLY CIRCUIT AND HYSTERESIS BUCK CONVERTER

(71) Applicant: Samsung Electronics Co., Ltd., Suwon-si (KR)

(72) Inventors: Kwangho Kim, Gyeonggi-do (KR); DongHun Heo, Seoul (KR)

(73) Assignee: Samsung Electronics Co., Ltd., Suwon-si (KR)

(21) Appl. No.: 14/029,048

(22) Filed: Sep. 17, 2013

(30) Foreign Application Priority Data
Sep. 27, 2012 (KR) 10-2012-0108082

(51) Int. Cl. H02M 3/157

(52) U.S. Cl. CPC H02M 3/157
USPC 323/283

(57) ABSTRACT

A power supply unit converting a DC power supply using an inductor includes a feedback circuit dividing an output voltage being output from a first end of the inductor to convert the output voltage into a first feedback voltage; a differentiator differentiating the first feedback voltage to convert the first feedback voltage into a second feedback voltage; a hysteresis comparator comparing a level of the second feedback voltage with a reference voltage band to output a comparison signal; and a switch pulling an input voltage up or pulling the input voltage down to the second end of the inductor with reference to the comparison signal.

### CROSS-REFERENCE TO RELATED APPLICATIONS

This U.S. non-provisional patent application claims priority under 35 U.S.C. §119 to Korean Patent Application No. 10-2012-0108082, filed on Sep. 27, 2012, the contents of which are herein incorporated by reference in their entirety.

### BACKGROUND

The present inventive concepts herein relate to semiconductor devices. More particularly, the present inventive concepts relate to a power supply circuit and a hysteresis buck converter that have a high speed response characteristic.

A power supply circuit is a basic means for driving various electronic devices. As the use of mobile device increases, demand for a high efficiency DC-to-DC converter increases. In particular, a mobile device requires a DC-to-DC converter that minimizes interference of a resistivity component. In a case in which a voltage drop method using a resistor is used, power consumption essentially increases. Thus, a buck converter using an inductor that can easily obtain a voltage of a target level, while minimizing power consumption, is often used as a DC-to-DC converter.

A buck converter is a power supply circuit that converts a high direct current voltage into a lower direct current voltage. A buck converter using an inductor having relatively low power consumption, as compared with a resistor, may provide high energy efficiency.

A hysteresis buck converter controlling a pull-up/pull-down switch using a hysteresis comparator uses a reference voltage Vref of a specific band. A hysteresis buck converter has an advantage of a high speed transient response and stability.

In the hysteresis buck converter, a switching frequency of the pull-up/pull-down switch is relatively low. Because of the low switching frequency, the hysteresis buck converter is vulnerable to a large current ripple flowing through an inductor. Because of the current ripple, a relatively large amount of noise is applied to a load.

### SUMMARY

According to an aspect of the present inventive concepts, there is provided a power supply unit converting a DC power supply using an inductor. The power supply unit may include a feedback circuit dividing an output voltage being output from a first end of the inductor to convert the output voltage into a first feedback voltage; a differentiator differentiating the first feedback voltage to convert the first feedback voltage into a second feedback voltage; a hysteresis comparator comparing a level of the second feedback voltage with a reference voltage band to output a comparison signal; and a switch pulling an input voltage up or pulling the input voltage down to a second end of the inductor with reference to the comparison signal.

In some embodiments, the differentiator controls a delay such that a phase of the second feedback voltage is synchronized with a phase of a current flowing through the inductor.

In some embodiments, a waveform of the second feedback voltage is configured to restore a waveform of the current flowing through the inductor.

In some embodiments, the differentiator includes an operational amplifier receiving the first feedback voltage through a non-inverting terminal; a capacitor connected between an inverting terminal of the operational amplifier and a ground; and a resistor connected between an output terminal of the operational amplifier and the inverting terminal of the operational amplifier. In some embodiments, at least one of the capacitor and the resistor is variable. In some embodiments,

In some embodiments, a period of pull-up or pull-down of the switch is controlled by controlling the at least one of the capacitor and the resistor.

In some embodiments, the feedback circuit comprises a first feedback resistor and a second feedback resistor for dividing the output voltage and wherein the first feedback resistor is variable.

In some embodiments, the reference voltage band corresponds to a linear section of the second feedback voltage.

In some embodiments, the reference voltage band corresponds to the gap between the minimum value and the maximum value of the second feedback voltage.

According to another aspect of the present inventive concepts, there is provided a hysteresis buck converter. The hysteresis buck converter may include a feedback circuit dividing an output voltage being output from a first end of an inductor to convert the output voltage into a feedback voltage; a hysteresis comparator comparing a level of the feedback voltage with a reference voltage band to output a comparison signal; a switch pulling an input voltage up or pulling the input voltage down to a second end of the inductor with reference to the comparison signal; and an adaptive hysteresis window controller adaptively controlling a hysteresis window such that the reference voltage band is proportional to the input voltage and is reverse proportional to the output voltage.

In some embodiments, the hysteresis window controller includes a hysteresis current generator generating a hysteresis current that is proportional to the input voltage and is reverse proportional to the output voltage; and a hysteresis voltage generator setting the reference voltage band with reference to the hysteresis current. In some embodiments, the hysteresis current generator comprises a variable resistor having a resistance value corresponding to feedback resistors included in the feedback circuit and wherein the variable resistor is proportional to the level of the output voltage. In some embodiments, the hysteresis current generator generates the hysteresis current having a level that is reverse proportional to the variable resistor and is proportional to the input voltage.

In some embodiments, the hysteresis voltage generator generates a first reference voltage and a second reference voltage according to the hysteresis current.

According to another aspect of the present inventive concepts, there is provided a hysteresis buck converter. The hysteresis buck converter may include an inductor having a first end and a second end; a feedback circuit converting an output voltage from the first end of the inductor into a first feedback voltage; a differentiator converting the first feedback voltage into a second feedback voltage; and a hysteresis comparator comparing a level of the second feedback voltage with a reference voltage band and outputting a comparison signal. The differentiator controls a delay such that a phase of the second feedback voltage is synchronized with a phase of a current flowing through the inductor.

In some embodiments, a switch, wherein the switch comprises a pull-up switch and a pull-down switch controlling an input voltage of the second end of the inductor in response to the comparison signal. In some embodiments, when the pull-up switch is activated, a power supply voltage is applied to the second end of the inductor and, when the pull-down switch is activated, the second end of the inductor is grounded.

In some embodiments, the differentiator may include an operational amplifier receiving the first feedback voltage through a non-inverting terminal; a capacitor connected between an inverting terminal of the operational amplifier and a ground; and a resistor connected between an output terminal of the operational amplifier and the inverting terminal of the operational amplifier. In some embodiments, at least one of the capacitor and the resistor is variable.

In some embodiments, the feedback circuit comprises a first feedback resistor and a second feedback resistor for dividing the output voltage and wherein the first feedback resistor is variable.

### BRIEF DESCRIPTION OF THE FIGURES

The foregoing and other features and advantages of the inventive concepts will be apparent from the more particular description of embodiments of the inventive concepts, as illustrated in the accompanying drawings in which like reference characters refer to the same parts throughout the different views. The drawings are not necessarily to scale, emphasis instead being placed upon illustrating the principles of the inventive concepts.

FIG. 1 is a circuit and block diagram illustrating a hysteresis buck converter in accordance with an example embodiment of the present inventive concepts.

FIG. 2 is a waveform diagram illustrating a function of a hysteresis comparator of FIG. 1 in accordance with an example embodiment of the present inventive concepts.

FIG. 3 is a circuit diagram illustrating a differentiator of FIG. 1 in accordance with an example embodiment of the present inventive concepts.

FIG. 4 is waveform diagrams illustrating forms of a feedback voltage in accordance with an example embodiment of the present inventive concepts.

FIGS. 5A and 5B are waveform diagrams illustrating an output of a hysteresis buck converter that does not include a differentiator and an output of a hysteresis buck converter including a differentiator, respectively.

FIG. 6 is a graph illustrating efficiency of a hysteresis buck converter in accordance with an example embodiment of the present inventive concepts.

FIG. 7 is a circuit and block diagram illustrating a hysteresis buck converter in accordance with an example embodiment of the present inventive concepts.

FIG. 8 is a block diagram illustrating an adaptive hysteresis window controller of FIG. 7 in accordance with an example embodiment of the present inventive concepts.

FIG. 9 is a circuit diagram illustrating a hysteresis current generator of FIG. 8 in accordance with an example embodiment of the present inventive concepts.

FIG. 10 is a circuit diagram illustrating an example embodiment of a hysteresis voltage generator of FIG. 8 in accordance with an example embodiment of the present inventive concepts.

FIG. 11 is a circuit diagram illustrating another example embodiment of a hysteresis voltage generator of FIG. 8 in accordance with an example embodiment of the present inventive concepts.

FIGS. 12A and 12B are graphs illustrating changes of switching frequency in accordance with some example embodiments of the present inventive concepts.

FIG. 13 is a block diagram illustrating a memory controller in accordance with some example embodiments of the present inventive concepts.

FIG. 14 is a block diagram illustrating a mobile device in accordance with some example embodiments of the present inventive concepts.

### DETAILED DESCRIPTION OF THE EMBODIMENTS

Various embodiments will be described more fully hereinafter with reference to the accompanying drawings, in which example embodiments are shown. These present inventive concepts may, however, be embodied in many different forms and should not be construed as limited to the embodiments set forth herein.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concepts.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present inventive concepts. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concepts.

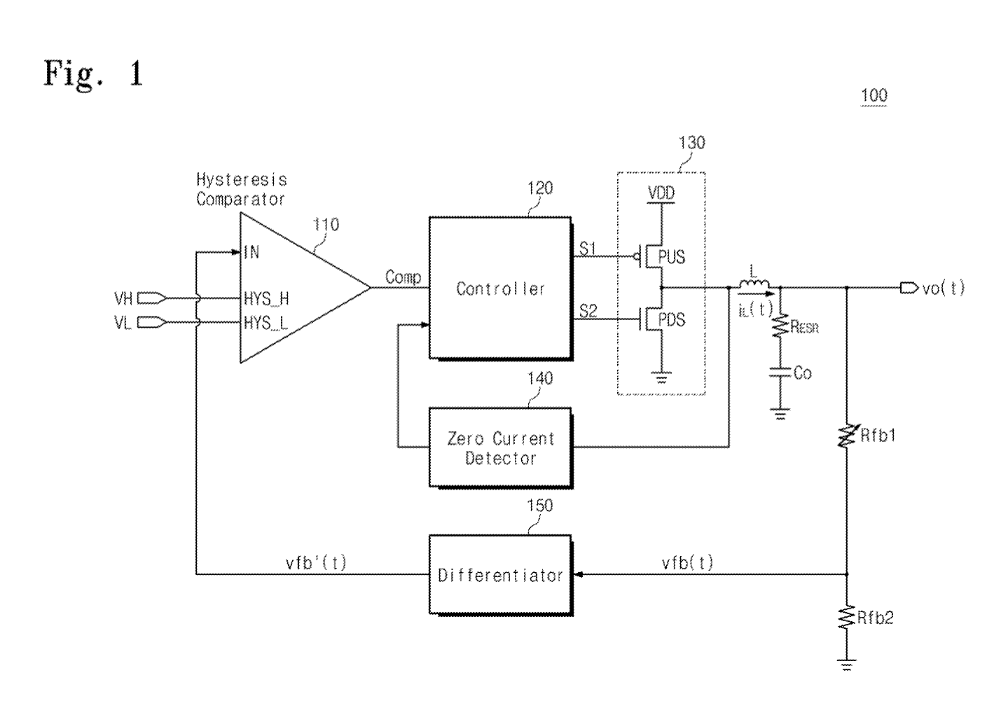

FIG. 1 is a circuit and block diagram illustrating a hysteresis buck converter 100 in accordance with an example embodiment of the present inventive concepts. Referring to FIG. 1, the hysteresis buck converter 100 includes an inductor L, an output capacitor Co, resistors R_{ESR}, Rfb1 and Rfb2, a hysteresis comparator 110, a controller 120, a switch 130, a zero current detector 140 and a differentiator 150.

The hysteresis comparator 110 has an input terminal IN and reference voltage terminals HYS_H and HYS_L. The hysteresis comparator 110 compares a feedback voltage vfb′(t) being provided to the input terminal IN with reference voltages VH and VL being provided to the reference voltage terminals HYS_H and HYSL, respectively. In an embodiment in which a level of the feedback voltage vfb′(t) is higher than a second reference voltage VH, the hysteresis comparator 110 may output a compare signal Comp of a logic ‘high’. While a logic ‘high’ is being output, if a level of the feedback voltage vfb′(t) is lower than a first reference voltage VL, the hysteresis comparator 110 transitions an compare signal Comp to a logic ‘low’. A driving method of the hysteresis comparator 110 may be set to operate in the opposite way to the output method described above. That is, in an embodiment in which a level of the feedback voltage vfb′(t) is higher than a second reference voltage VH, the hysteresis comparator 110 may output a compare signal Comp of a logic ‘low’. While a logic ‘low’ is being output, if a level of the feedback voltage vfb′(t) is lower than a first reference voltage VL, the hysteresis comparator 110 transitions an compare signal Comp to a logic ‘high’.

The controller 120 controls the switch 130 with reference to a compare signal Comp being output from the hysteresis comparator 110 and an output of the zero current detector 140. The controller 120 outputs a first switching signal S1 and a second switching signal S2 according to the compare signal Comp being provided from the hysteresis comparator 110. The first swithing signal S1 and the second switching signal S2 control the switch 130. The first switching signal S1 drives a pull-up switch (PUS) of the switch 130 and the second switching signal S2 drives a pull-down switch (PDS) of the switch 130. The controller 120 may be configured to turn on the pull-up switch (PUS) and turn off the pull-down switch (PDS) in a section of logic ‘high’ of the compare signal Comp. The controller 120 may be configured to turn off the pull-up switch (PUS) and turn on the pull-down switch (PDS) in a section of logic ‘low’ of the compare signal Comp.

The switch 130 applies a voltage to the inductor L in response to the switching signals S1 and S2. The switch 130 receives a power supply voltage VDD. If the first switching signal S1 is activated, the pull-up switch (PUS) is turned on and the power supply voltage VDD is applied to the inductor L and the output capacitor Co. An effective series resistor R_{ESR} is a resistivity component caused by connecting the capacitor Co. If the effective series resistance R_{ESR} increases, voltage drop and power consumption of the circuit increase. It is preferable that the value of the effective series resistance R_{ESR} remain as small as possible. If the second switching signal S2 is activated, the pull-down switch (PDS) is turned on and one end of the inductor L is grounded. Thus, if the second switching signal S2 is activated, a forward current flowing through the inductor L is reduced.

The output capacitor Co performs a function of a low pass filter. The feedback resistors Rfb1 and Rfb2 divide an output voltage vo(t) to provide a voltage of a proper level to the differentiator 150. The feedback resistor Rfb1 may be variable.

The zero current detector 140 detects a time at which an inductor current i_{L}(t) becomes 0. According to a pull-up operation and a pull-down operation, a current flowing through the inductor L may increase or decrease. However, the inductor current i_{L}(t) has to increase or decrease in a direct current bias state. If the inductor current i_{L}(t) becomes 0 due to an excessive pull-down operation, the buck converter 100 cannot operate as a power supply. Thus, the zero current detector 140 detects whether the inductor current i_{L}(t) becomes 0 and transfers the detected content to the controller 120. Then, the controller 120 generates a switching signal increasing a pull-up section.

The differentiator 150 performs a differential operation on the feedback voltage vfb(t) to transfer a differential operation result vfb′(t) to the input terminal IN of the hysteresis comparator 110. The differentiator 150 may include a resistor Rd and a capacitor Cd. A phase of the feedback voltage vfb(t) is shifted by 90° by a capacitor Cd of the differentiator 150 while passing through the differentiator 150. Because of the phase shift, a feedback voltage vfb′(t) being provided to the hysteresis comparator 110 may have a waveform having approximately the same phase as the inductor current i_{L}(t).

The resistor Rd and the capacitor Cd included in the differentiator 150 may be variable. That is, a level or a phase of the differentiated feedback voltage vfb′(t) may be controlled through a variable resistor and/or a variable capacitor. If a resistance value of the resistor Rd or capacitance value of the capacitor Cd is controlled, a switching frequency of the hysteresis buck converter 100 may be set to the optimum frequency.

According to the hysteresis buck converter 100, a phase delayed by the output capacitor Co may be compensated through the differentiator 150. The feedback voltage vfb′(t) having the same phase as the inductor current i_{L}(t) may be provided to the hysteresis comparator 110. According to that operation, a band of the reference voltage of the hysteresis comparator 110 may be widened. The hysteresis comparator 110 can increase a switching frequency fsw without increasing a resistance value of a resistor which is a main cause of power consumption.

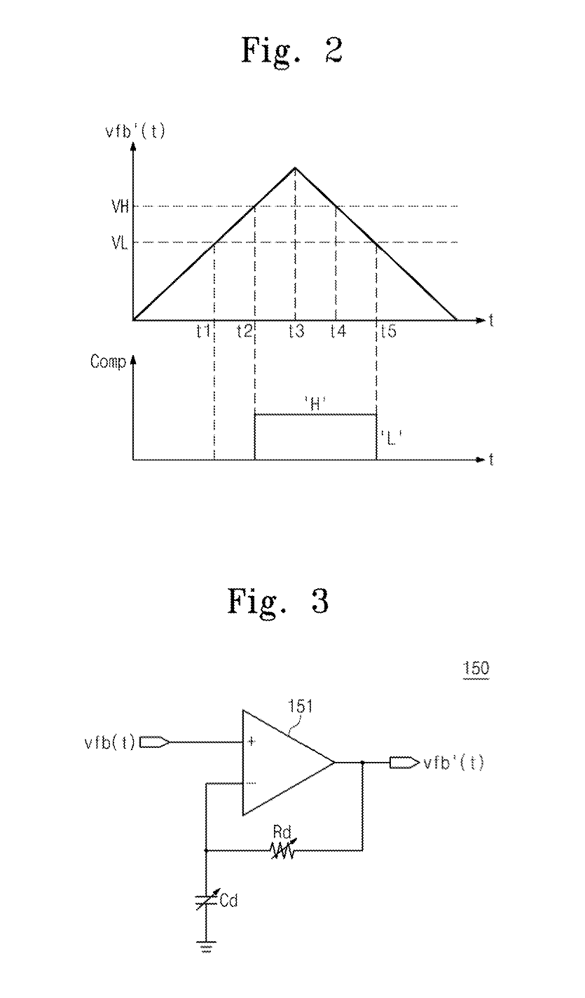

FIG. 2 is a waveform diagram illustrating a function of the hysteresis comparator 100 of FIG. 1 in accordance with an example embodiment of the present inventive concepts. Referring to FIG. 2, the hysteresis comparator 110 operates on the basis of two threshold voltages VL and VH with respect to the feedback voltage vfb′(t).

First, it is assumed that the feedback voltage vfb′(t) being provided to the input terminal IN of the hysteresis comparator 110 has a triangular waveform that increases until time t3 and decreases after the time t3. Assume that an initial state of the compare signal Comp output from the hysteresis comparator 110 is logic ‘Low’.

The feedback voltage vfb′(t) being provided to the input terminal IN of the hysteresis comparator 110 gradually increases. A level of the feedback voltage vfb′(t) becomes higher than the first reference voltage VL at time t1. In the case in which a state of the current compare signal Comp output from the hysteresis comparator 110 is logic ‘Low’, the compare signal Comp will not be reversed until the feedback voltage vfb′(t) is higher than the second reference voltage VH. Thus, even though a level of the feedback voltage vfb′(t) is higher than the first reference voltage VL, if a level of the feedback voltage vfb′(t) is lower than the second reference voltage VH, an output of the hysteresis comparator 110 may maintain a logic ‘Low’.

At time t2, a level of the feedback voltage vfb′(t) becomes higher than the second reference voltage VH. At this time, the hysteresis comparator 110 may transition a level of the compare signal Comp to logic ‘High’. A level of the feedback voltage vfb′(t) has to be higher than the second reference voltage VH in order for the compare signal Comp to transition from logic ‘Low’ to logic ‘High’.

A level of the feedback voltage vfb′(t) begins to decrease from time t3. At this time, the hysteresis comparator 110 may maintain a level of the compare signal Comp at logic ‘High’. At time t4, a level of the feedback voltage vfb′(t) begins to decrease below the second reference voltage VH. However, the hysteresis comparator 110 maintains a level of the compare signal Comp at logic ‘High’. In the case in which a current compare signal Comp is a logic ‘High’ state, the hysteresis comparator 110 transitions a level of the compare signals Comp to logic ‘Low’ only when a level of the feedback voltage vfb′(t) becomes lower than the first reference voltage VL. That is, the hysteresis comparator 110 transitions a level of the compare signal Comp to logic ‘Low’ at time t5 when a level of the feedback voltage vfb′(t) becomes lower than the first reference voltage VL.

In the hysteresis comparator 110, when a level of an input signal received at input IN increases, the first reference voltage VH becomes a threshold voltage and when a level of an input signal decreases, the second reference voltage VL becomes a threshold voltage.

FIG. 3 is a circuit diagram illustrating an example embodiment of the differentiator of FIG. 1 in accordance with an example embodiment of the present inventive concepts. Referring to FIG. 3, the differentiator 150 may include an operational amplifier 151.

The feedback voltage vfb(t) is input to a non-inverting input terminal (+) of the operational amplifier 151. A resistor Rd is connected between an inverting input terminal (−) and an output terminal and a capacitor Cd is connected between the inverting input terminal (−) and a ground. The differentiator 150 may be implemented using a virtual ground concept in which a voltage difference between the non-inverting input terminal (+) and the inverting input terminal (−) is zero and a current flowing into the differentiator 150 is 0. According to the implementation using the virtual ground concept, a transfer function of and input and an output of the differentiator 150 may be expressed by mathematical formula 1 below.

T(s)=1+s R_{d}C_{d} [mathematical formula 1]

In considering the transfer function, an alternating current (AC) gain may increase due to a resistor Rd and a capacitor Cd. An output signal of the differentiator 150 is phase shifted by about 90° with respect to an input signal of the differentiator 150.

The resistor Rd and the capacitor Cd included in the differentiator 150 may be variable. A level or phase of the differentiated feedback voltage vfb′(t) may be controlled by a resistance value of the resistor Rd or a capacitance value of the capacitor Cd. That is, by controlling the resistance value of the resistor Rd or the capacitance value of the capacitor Cd of the differentiator 150, a switching frequency fsw of the hysteresis buck converter 100 may be controlled. If a resistance value of the resistor Rd or capacitance of the capacitor Cd is optimally controlled, the switching frequency fsw of the hysteresis buck converter 100 may be increased and a stable output voltage vo(t) can be provided.

The differentiator 150 is not limited to the operational amplifier 151 described above. Any circuits in which a gain and a phase shift between input and output signals are set to correspond to a characteristic of the differentiator 150 may replace the differentiator 150.

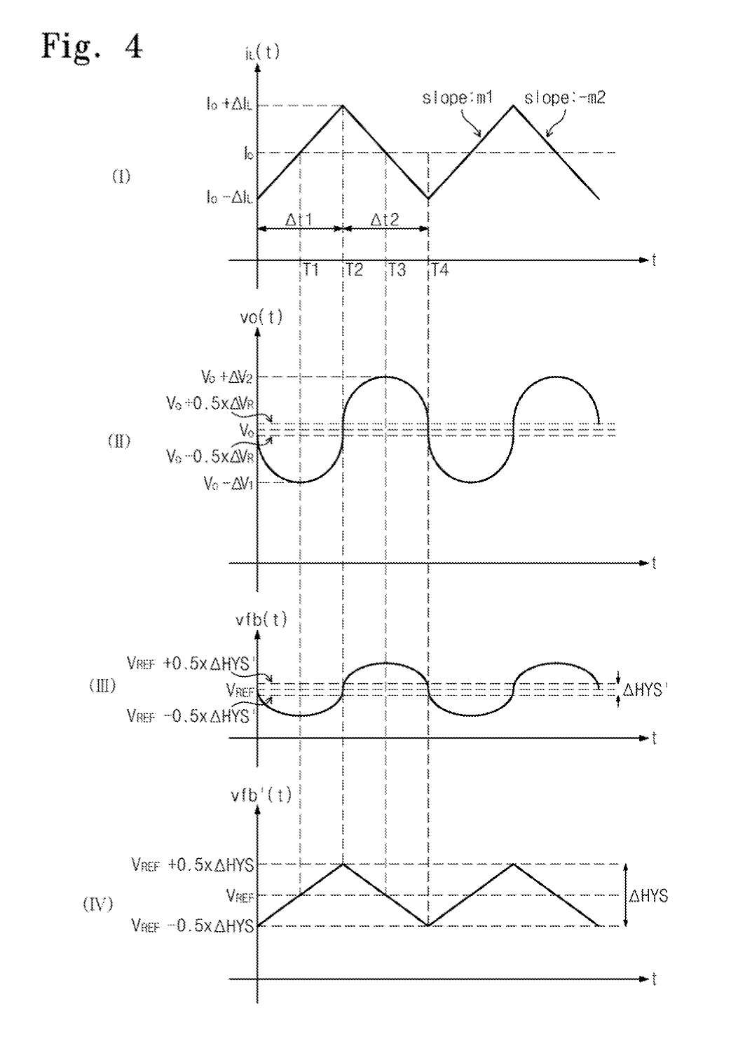

FIG. 4 is a waveform diagram illustrating an operation of the hysteresis buck converter 100 of the example embodiment of FIG. 1. Referring to FIG. 4, an inductor current i_{L}(t), an output voltage vo(t), a feedback voltage vfb(t) and an output voltage vfb′(t) of the differentiator 150 are illustrated. Each waveform is illustrated based on the assumption that elements constituting the hysteresis buck converter 100 have no signal delay and have an infinite gain.

In a waveform diagram (I) of FIG. 4, a waveform of an inductor current i_{L}(t) is illustrated. The waveform of the inductor current i_{L}(t) is provided in the form of a triangular wave shape having a period of (Δt1+Δt2). The inductor current i_{L}(t) corresponds to energy stored in the inductor L according to pull-up/pull-down operations of the switch 130. The inductor current i_{L}(t) flowing through the inductor L has alternating current levels corresponding to the maximum point (Io+ΔI_{L}) and the minimum point (Io−ΔI_{L}) on the basis of an average current (Io). If the pull-up switch PUS is turned on, the inductor current i_{L}(t) increases from the minimum point (Io−ΔI_{L}) to the maximum point (Io+ΔI_{L}). After that, if the pull-down switch PDS is turned on, the inductor current i_{L}(t) decreases from the maximum point (Io+ΔI_{L}) to the minimum point (Io−ΔI_{L}). An increase section (Δt1) of the waveform and a decrease section of the waveform (Δt2) of the inductor current i_{L}(t) may be variously controlled according to a characteristic of the hysteresis buck converter 100. A slope (m1) of a pull-up section of the waveform and a slope (−m2) of a pull-down section of the waveform of the inductor current i_{L}(t) may be variously controlled by the switching signals S1 and S2.

In a waveform diagram (II) of FIG. 4, a waveform of an output voltage vo(t) in accordance with the inductor current i_{L}(t) is illustrated. The output voltage vo(t) becomes lower than an offset voltage Vo in a section of the waveform where energy is accumulated in the inductor L by the switch 130. In a section (0−T2) of the waveform where the inductor current i_{L}(t) increases, voltages appearing across the effective series resistor R_{ESR} and the output capacitor Co decrease, and then increase, but remain below the offset voltage Vo. The output voltage vo(t) increases above the offset voltage Vo in a section of the waveform where energy in the inductor L is discharged. That is, in a section (T2−T4) of the waveform in which the inductor current i_{L}(t) decreases, voltages appearing across the effective series resistor R_{ESR} and the output capacitor Co increase above the offset voltage Vo, and then decrease.

In a waveform diagram (III) of FIG. 4, a feedback voltage vfb(t) is illustrated. The feedback voltage vfb(t) is output voltage vo(t) divided by the feedback resistors Rfb1 and Rfb2. That is, a level of the output voltage vo(t) is dropped across the feedback resistor Rfb1 to become the feedback voltage vfb(t). The feedback voltage vfb(t) has the same waveform as the output voltage vo(t) and a level of the feedback voltage vfb(t) is smaller than a level of the output voltage vo(t).

The feedback voltage vfb(t) is insufficient to reflect variation of the inductor current i_{L}(t) in real time. In a section (0−T2) of the waveform where the inductor current i_{L}(t) increases, increase and decrease of a level of the feedback voltage vfb(t) may occur. Since the feedback voltage vfb(t) has a relatively low voltage level, a hysteresis window (ΔHYS′) is relatively narrow. Thus, a discriminating ability of the hysteresis comparator 110 is reduced due to the narrow hysteresis window (ΔHYS′).

In a waveform diagram (IV) of FIG. 4, a waveform of a feedback voltage vfb′(t) is illustrated which is a voltage that the feedback voltage vfb(t) is differentiated. Referring to the differentiated feedback voltage vfb′(t), a level of the feedback voltage vfb′(t) linearly increases from time 0 to time T2 and linearly decreases from time T2 to time T4. According to the feedback voltage vfb′(t), an input of the hysteresis comparator 110 may have section linearity. Thus, limitation of the hysteresis window (AHYS) caused by nonlinearity of the feedback voltage vfb(t) may be solved.

A waveform of the differentiated feedback voltage vfb′(t) reflects increase and decrease of the inductor current i_{L}(t) in real time. In the case in which the differentiated feedback voltage vfb′(t) is provided to the hysteresis comparator 110, the hysteresis comparator 110 may more accurately operate at high speed.

According to an aspect of the present inventive concepts, the inductor current i_{L}(t) and the differentiated feedback voltage vfb′(t) have the same phase. A pull-down/pull-up operation may be controlled by the feedback voltage vfb′(t) having the same phase as the inductor current i_{L}(t). That is, a rapid switching can be performed without a delay with respect to the inductor current i_{L}(t). The rapid switching control means an increase of switching frequency fsw of the hysteresis buck converter 100. The increase of the switching frequency fsw means that the hysteresis buck converter 100 may be used as a stable power supply having high conversion efficiency and may generate an output voltage having a reduced ripple.

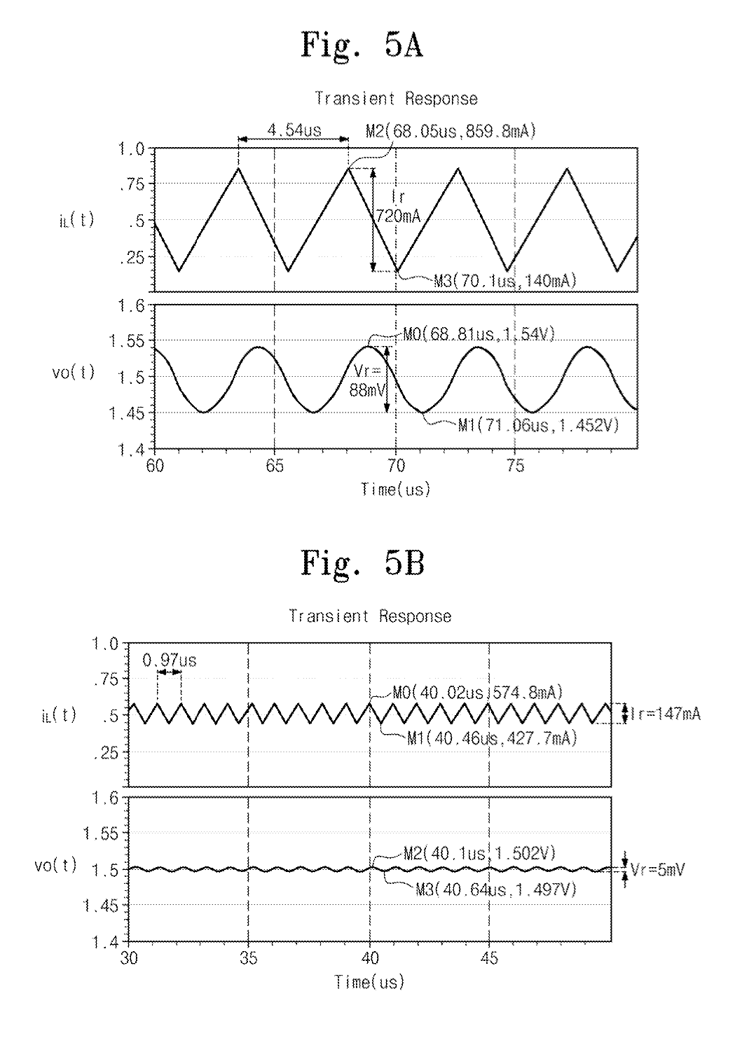

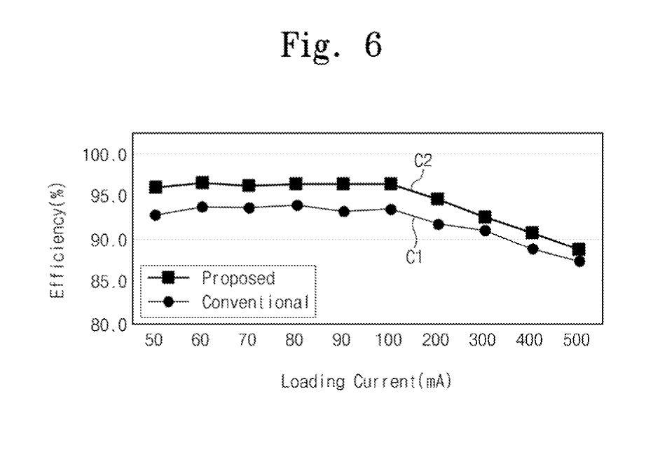

FIGS. 5A and 5B are waveforms illustrating a characteristic of the present inventive concepts inventive concepts, in accordance with an example embodiment of the present inventive concepts. FIG. 5A illustrates waveforms of the inductor current i_{L}(t) and the output voltage vo(t) when the feedback voltage vfb(t) is directly input to the hysteresis comparator 110. FIG. 5B illustrates waveforms of the inductor current i_{L}(t) and the output voltage vo(t) when the feedback voltage vfb′(t) which passed through the differentiator 150 is input to the hysteresis comparator 110.

Referring to FIG. 5A, assuming that a load current is 500 mA, waveforms of the inductor current i_{L}(t) and the output voltage vo(t) of a hysteresis comparator 110 which does not use the differentiator 150 are illustrated. Referring to the inductor current i_{L}(t), a switching occurs by the feedback voltage vfb(t) that is not differentiated. In this case, a pull-up/pull-down operation is controlled by a relatively small switching frequency fsw.

Referring to the inductor current i_{L}(t) of FIG. 5A, a level difference between the minimum current and the maximum current by the switching is about 720 Ma. The level difference corresponds to amplitude of a ripple of the inductor current i_{L}(t). A period of the inductor current i_{L}(t) having a triangular waveform is about 4.54 μs and this corresponds to a switching frequency fsw of about 220 kHz.

In considering the output voltage vo(t) of FIG. 5A, the output voltage vo(t) varies while having a different phase from the inductor current i_{L}(t). However, the output voltage vo(t) has the same period as the inductor current i_{L}(t). The output voltage vo(t) includes a ripple of about 88 mV. This is an inadequate value for a stable power supply.

Referring to FIG. 5B, an inductor current and an output voltage of the hysteresis buck converter 100 which uses the differentiator 150 to provide a load current of 500 mA are illustrated. Referring to the inductor current i_{L}(t), a switching occurs by the differentiated feedback voltage vfb′(t). In this case, a pull-up/pull-down is controlled by a relatively high switching frequency.

Referring to a waveform of the inductor current i_{L}(t) in FIG. 5B, a level difference between the minimum current and the maximum current by the switching is about 147 mA. That is, a ripple of the inductor current i_{L}(t) is greatly reduced as compared with the case of not using the differentiator 150. A period of the inductor current i_{L}(t) having a triangular waveform is about 0.97 μs and this corresponds to a switching frequency fsw of about 1.024 MHz.

In considering the output voltage vo(t) of FIG. 5B, the output voltage vo(t) varies while having the same phase as the inductor current i_{L}(t). The output voltage vo(t) has the same period (about 0.97 μs) as the inductor current i_{L}(t). The output voltage vo(t) includes a ripple of about 5 mV. This is an adequate value for a stable power supply. According to the example embodiment of the present inventive concepts, as illustrated in FIG. 5B, in the hysteresis buck converter 100, the switching frequency fsw may be increased at least four times and a ripple of the inductor current i_{L}(t) may be reduced by about one-fifth as compared with the embodiment in which the differentiator 150 is not used. As illustrated in FIG. 5B, a ripple of the output voltage vo(t) of the hysteresis buck converter 100 may be reduced to less than 6% as compared with the embodiment in which the differentiator 150 is not used.

According to the example embodiment of the present inventive concepts providing a feedback voltage using the differentiator 150, a switching frequency fsw of the hysteresis buck converter 100 may be greatly increased. The hysteresis buck converter 100 of the present inventive concepts may be used as a stable power supply due to the increase of the switching frequency.

FIG. 6 is a graph illustrating efficiency of the hysteresis buck converter 100 of the present inventive concepts. Referring to FIG. 6, the graph illustrates conversion efficiency of the hysteresis buck converter 100 relative to a loading current when, respectively, using and not using the differentiator 150.

Efficiency of the hysteresis buck converter 200 which uses the differentiator 150 is illustrated by a curve C2. Efficiency of a hysteresis buck converter which does not use the differentiator 150 is illustrated by a curve C1. When considering the efficiency curve C1 of the hysteresis buck converter which does not use the differentiator 150, conversion efficiency is always less than 95% regardless of a condition of the loading current. When considering the efficiency curve C2 of the hysteresis buck converter 100 which uses the differentiator 150, conversion efficiency is more than 95% until the loading current is 100 mA. According to the hysteresis buck converter 100 of the present inventive concepts, even if the load increases, the hysteresis buck converter 100 may have efficiency improved by about 1.3%˜3.4% as compared with the embodiment in which the differentiator 150 is not used.

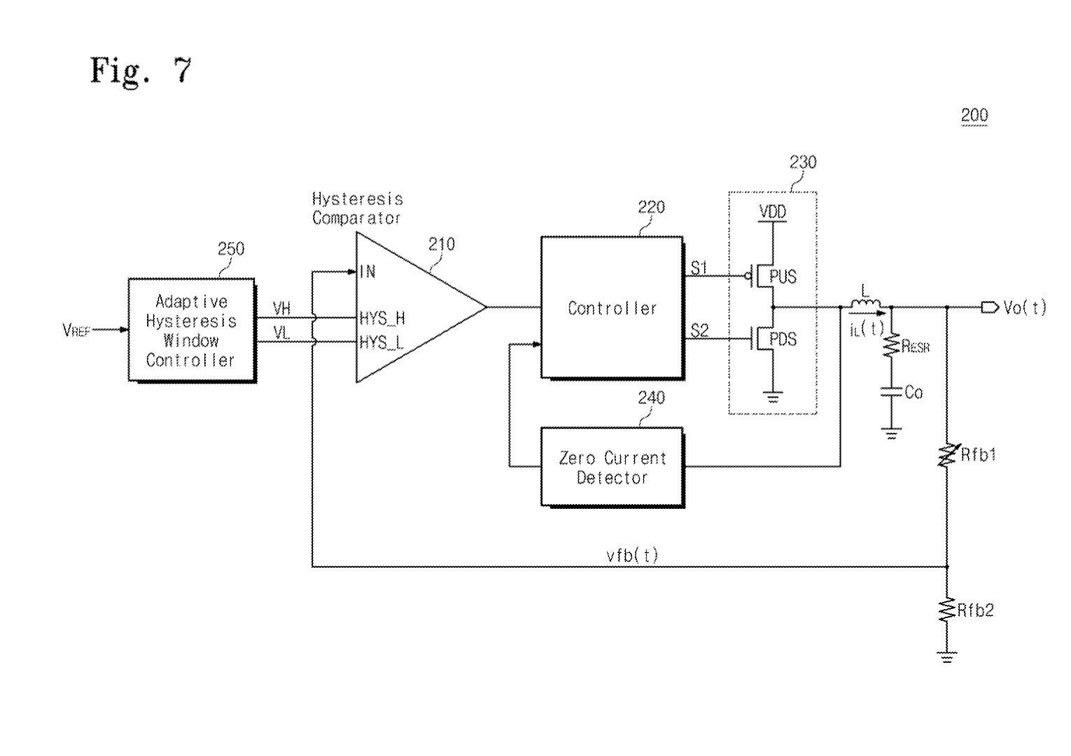

FIG. 7 is a circuit and block diagram illustrating a hysteresis buck converter 200 in accordance with an example embodiment of the present inventive concepts. Referring to FIG. 7, the hysteresis buck converter 200 includes an inductor L, an output capacitor Co, resistors R_{ESR}, Rfb1 and Rfb2, a hysteresis comparator 210, a controller 220, a switch 230, a zero current detector 240 and an adaptive hysteresis window controller 250. The resistor Rfb1 may be variable.

The hysteresis comparator 210, the controller 220, the switch 230 and the zero current detector 240 are the same as those described in connection with FIG. 1. Thus, descriptions of the hysteresis comparator 210, the controller 220, the switch 230 and the zero current detector 240 are omitted.

The adaptive hysteresis window controller 250 can adaptively control a reference voltage Vref of the hysteresis comparator 210 according to an input voltage VDD or an output voltage Vo(t). The adaptive hysteresis window controller 250 generates a hysteresis window (AHYS=VH−VL) which is proportional to the input voltage VDD and is inverse proportional to the output voltage Vo(t).

A variation of a switching frequency fsw may be reduced by the hysteresis window (AHYS) which is proportional to the input voltage VDD and is inverse proportional to the output voltage Vo(t). Thus, a noise spectrum may be reduced by the stabalization of the switching frequency fsw. A noise flowing in a load is easily cut off. Since a switching loss and a conduction loss can be optimized by the stabalization of the switching frequency fsw, an efficient buck converter 200 may be implemented.

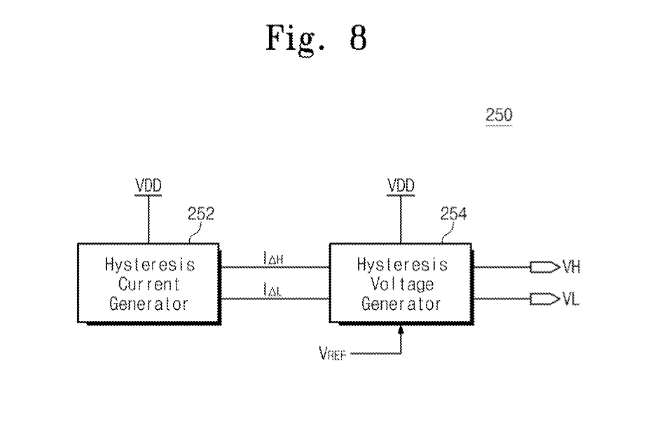

FIG. 8 is a block diagram illustrating the adaptive hysteresis window controller 250 of FIG. 7 in accordance with an example embodiment of the present inventive concepts. Referring to FIG. 8, the hysteresis window controller 250 includes a hysteresis current generator 252 and a hysteresis voltage generator 254.

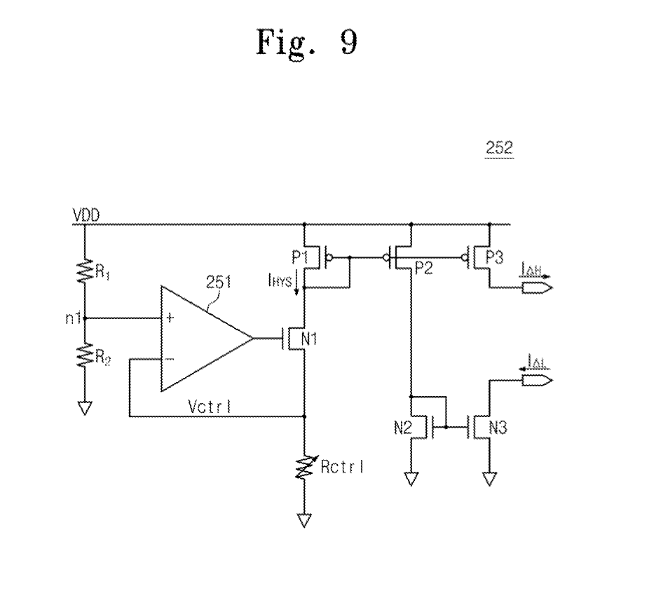

FIG. 9 is a circuit diagram illustrating the hysteresis current generator 252 of FIG. 8. Referring to FIGS. 8 and 9, the hysteresis window controller 250 receives a reference voltage Vref and outputs a first reference voltage VH and a second reference voltage VL. The hysteresis current generator 252 is provided with the input voltage VDD as a power supply. The hysteresis current generator 252 includes a control resistor Rctrl corresponding to the sum of variable feedback resistors Rfb1 and Rfb2 of FIG. 7. The hysteresis current generator 252 generates a hysteresis current I_{HYS} which is reverse proportional to a control resistor Rctrl using the input voltage VDD as a source. Using the generated hysteresis current I_{HYS}, the hysteresis current generator 252 generates a first reference current (LH) and a second reference current (I_{ΔL}).

The hysteresis voltage generator 254 receives the reference voltage Vref and the power supply voltage VDD and generates a first reference voltage VH and a second reference voltage VL using the first reference current (I_{ΔH}) and the second reference current (I_{ΔL}) being provided from the hysteresis current generator 252. A level difference between the first and second reference voltages VH and VL corresponds to a hysteresis window being input in the hysteresis comparator 210.

Referring to FIG. 9, the hysteresis current generator 252 may comprise a current source circuit using an operational amplifier 251.

The hysteresis current generator 252 generates the hysteresis current I_{HYS} which is proportional to the input voltage VDD and is reverse proportional to the output voltage Vo(t). The hysteresis current generator 252 generates the first reference current (I_{ΔH}) and the second reference current (I_{ΔL}) with reference to the hysteresis current I_{HYS}.

The input voltage VDD is divided by series resistors R1 and R2. A voltage at a node nl, which is a voltage appearing across the resistor R1, is input to a non-inverting input terminal (+) of the operational amplifier 251. An output terminal of the operational amplifier 251 is connected to a gate of an NMOS transistor N1. A control voltage Vctrl appearing across the control resistor Rctrl is expressed by mathematical formula 2 below.

$$Vctrl = VDD ( \frac{{R}_{2}}{{R}_{1} + {R}_{2}} ) \qquad [ mathematical formula 2 ]$$

R1 and R2 are a fixed resistance value. The control resistor Rctrl may be a variable resistor and may be expressed by mathematical formula 3 below.

$$\begin{matrix}Rctrl = Rfb 1 + Rfb 2 \\ = Vo ( \frac{Rfb 2}{{V}_{REF}} )\end{matrix} \qquad [ mathematical formula 3 ]$$

According to the value of the control resistor Rctrl described above, a current flowing through the control resistor Rctrl may be expressed by mathematical formula 4.

$$\begin{matrix}{I}_{HYS} = \frac{Vctrl}{Rctrl} \\ = ( \frac{{R}_{2}}{{R}_{1} + {R}_{2}} ) ( \frac{{V}_{REF}}{Vfb 2} ) ( \frac{VDD}{Vo} ) \\ = {K}_{1} ( \frac{VDD}{Vo} )\end{matrix} \qquad [ mathematical formula 4 ]$$

Referring to mathematical formula 3 described above, due to the control resistor Rctrl, the hysteresis current I_{HYS} being generated by the hysteresis current generator 252 is proportional to the input voltage VDD and is reverse proportional to the output voltage Vo(t).

The first reference current (I_{ΔH}) and the second reference current (I_{ΔL}) are generated through a current mirror circuit on the basis of the hysteresis current I_{HYS}. The current generator 252 may include PMOS transistors P1, P2 and P3 and NMOS transistors N2 and N3. The amount of the first reference current (Iₘ) and the second reference current (I_{ΔL}) flowing through a PMOS transistor P3 and an NMOS transistor N3 respectively is the same as the amount of the hysteresis current I_{HYS}. Levels of the first reference current (I_{ΔH}) and the second reference current (I_{ΔL}) are proportional to the input voltage VDD and are reverse proportional to the output voltage Vo(t).

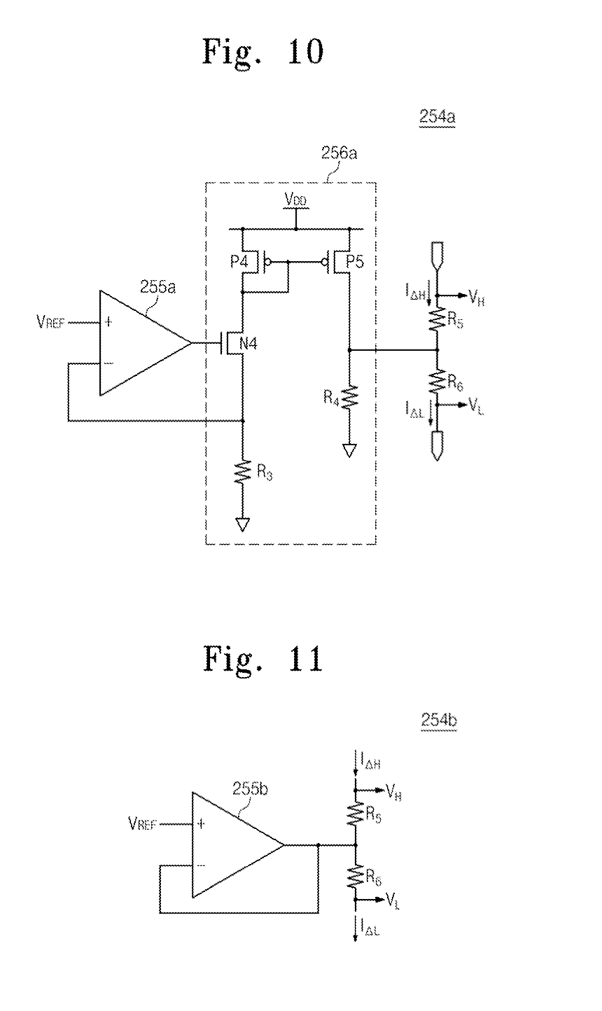

FIG. 10 is a circuit diagram illustrating an example of a hysteresis voltage generator 254 of FIG. 8. Referring to FIG. 10, a hysteresis voltage generator 254a converts the first reference current (I_{ΔH}) and the second reference current (I_{ΔL}) being provided from the hysteresis current generator 252 into hysteresis reference voltages VH and VL, respectively.

According to the hysteresis voltage generator 254a, in order for the hysteresis voltage generator 254a to comprise a current source circuit using a reference voltage Vref, an operational amplifier 255a and a current mirror part 256a are provided. An output terminal of the operational amplifier 255a is connected to a gate of an NMOS transistor N4. The hysteresis voltage generator 254a may generate the hysteresis reference voltages VH and VL which are not greatly affected by a current generated from the operational amplifier 255a and the current mirror part 256a. This is because a result of the hysteresis voltage generator 254a being provided with the first reference current (I_{ΔH}) and the second reference current (I_{ΔL}) generated from the hysteresis current generator 252 to generate the hysteresis reference voltages VH and VL corresponding thereto. In this structure, as illustrated in FIG. 10, currents flowing through the PMOS transistors P4 and P5 of the current mirror part 256a do not have to be large. Regardless of resistors R3, R4, R5 and R6, the first reference current (I_{ΔH}) and the second reference current (I_{ΔL}), which are relatively large, may be used to generate hysteresis reference voltages VH and VL.

An error due to discrepancy of the reference currents may be reduced greatly by generating the first reference current (I_{ΔH}) and the second reference current (I_{ΔL}) while reducing the resistors R5 and R6.

FIG. 11 is a circuit diagram illustrating another example embodiment of a hysteresis voltage generator 254 of FIG. 8. Referring to FIG. 11, a hysteresis voltage generator 254b may include the hysteresis voltage generator 254a of FIG. 10, except the hysteresis voltage generator 254b does not include the current mirror part 256a. The hysteresis voltage generator 254b may include operation amplifier 255b.

This structure of the hysteresis voltage generator 254b, as illustrated in FIG. 11, is possible due to the hysteresis current generator 252 generating the first reference current (I_{ΔH}) and the second reference current (I_{ΔL}) with sufficiently large values.

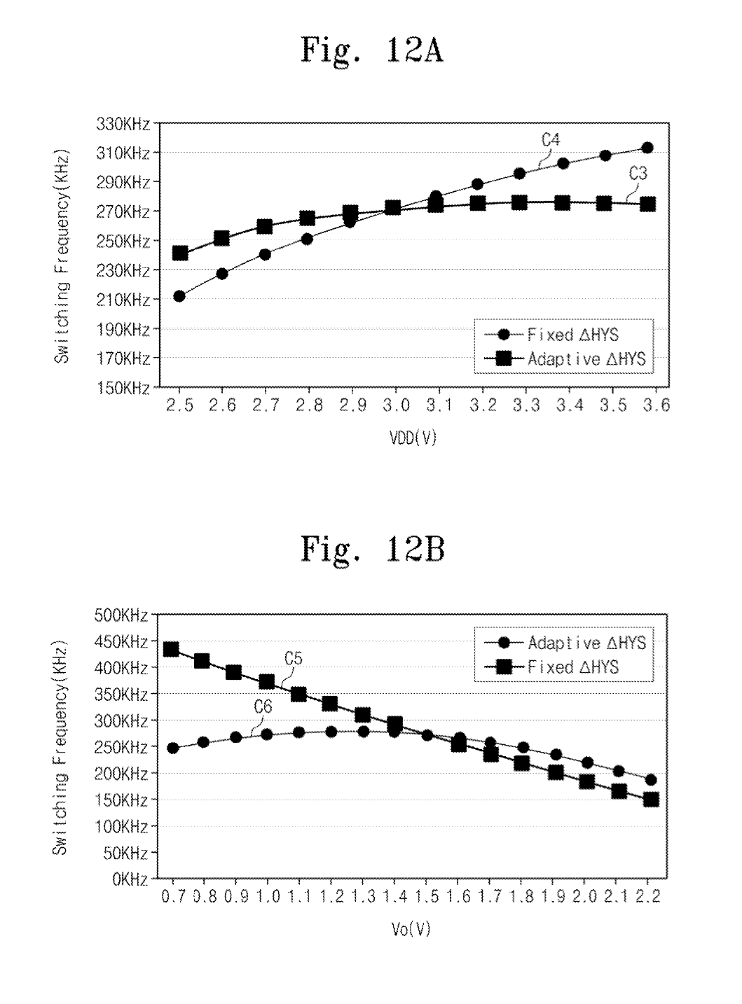

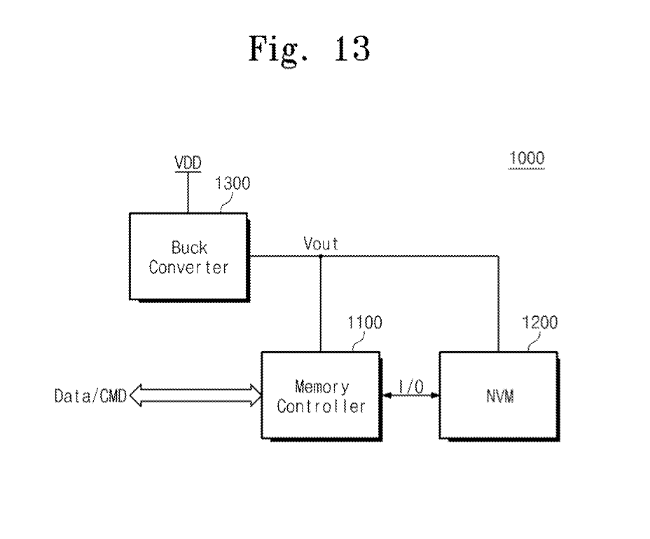

FIGS. 12A and 12B are graphs illustrating changes of switching frequency in accordance with some example embodiments of the present inventive concepts. FIG. 12A illustrates a change of a switching frequency relative to an input voltage VDD. FIG. 12B illustrates a change of a switching frequency relative to the output voltage Vo.

Referring to FIG. 12A, when changing the input voltage VDD from 2.5V to 3.6V while fixing the output voltage Vo to 1.5V, a change of a switching frequency fsw is briefly illustrated. A curve C4 illustrates a change of the switching frequency fsw when the hysteresis reference voltage is fixed. A curve C3 illustrates a change of the switching frequency fsw when applying a hysteresis reference voltage which adaptively varies in accordance with the example embodiment of FIG. 7 of the present inventive concepts. A change of a switching frequency fsw of the buck converter, for example, hysteresis buck converter 200 of the present inventive concepts, as illustrated by curve C3, is reduced to about 33% on a basis of 280 KHz as compared with a fixed hysteresis reference voltage condition, as illustrated by curve C4.

Referring to FIG. 12B, when changing the output voltage Vo from 0.7V to 2.2V while fixing the input voltage VDD to 30V, a change of the switching frequency fsw is briefly illustrated. A curve C5 illustrates a change of the switching frequency fsw when the hysteresis reference voltage is fixed. A curve C6 illustrates a change of the switching frequency fsw when applying a hysteresis reference voltage which adaptively varies in accordance with the example embodiment of FIG. 7 of the present inventive concepts. A change of a switching frequency fsw of the buck converter of the present inventive concepts, for example, hysteresis buck converter 200, is reduced to about 25% on a basis of 280 KHz, as illustrated by curve C6, as compared with a fixed hysteresis reference voltage condition, as illustrated by curve C5.

FIG. 13 is a block diagram illustrating a memory system 1000 in accordance with an example embodiment of the present inventive concepts. Referring to FIG. 13, the memory system 1000 includes a memory controller 1100, a nonvolatile memory 1200 and a buck converter 1300. The memory controller 1100 inputs/outputs data and command signals Data/CMD. The memory controller 1100 and the nonvolatile memory 1200 exchange I/O data. The buck converter 1300 supplies a voltage Vout to the memory controller 1100 and the nonvolatile memory 1200. The buck converter 1300 is substantially the same as the hysteresis buck converters 100 and 200 described in connection with FIG. 1 and FIG. 7, respectively.

The buck converter 1300 may be provided according to the embodiment in which a feedback voltage is differentiated to be input to a hysteresis comparator, referring to FIG. 1, or the embodiment in which a hysteresis window is adaptively changed according to a level of an input or output voltage, referring to FIG. 7.

The buck converter 1300 applying such technology may operate as a stable DC power supply having a reduced ripple through a high switching frequency. The buck converter 1300 may operate as a DC-to-DC converter which operates with a stable switching frequency with respect to a change of an input or output voltage.

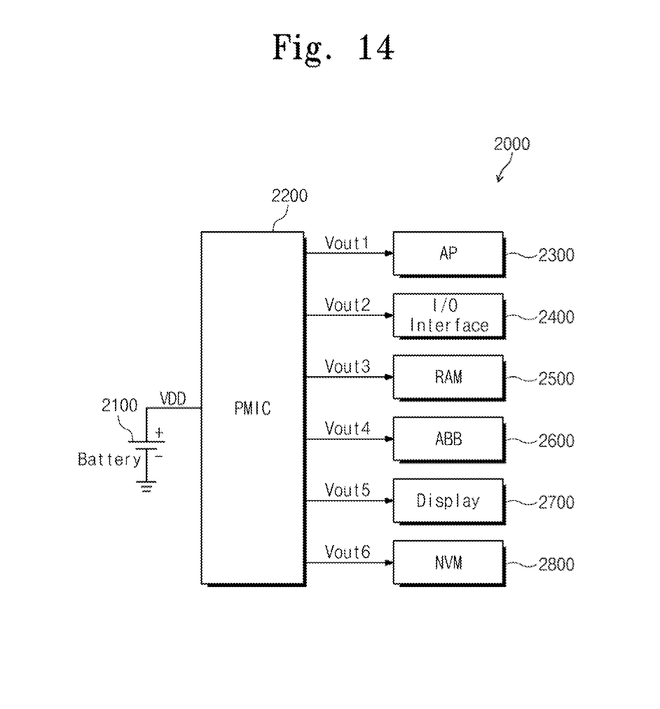

FIG. 14 is a block diagram illustrating a mobile device 2000 in accordance with an example embodiment of the present inventive concepts. Referring to FIG. 14, the mobile device 2000 may include a battery 2100, a power supply circuit 2200, an application processor 2300, an input/output interface 2400, a RAM 2500, an analog baseband chipset 2600, a display 2700 and a nonvolatile memory 2800.

The power supply 2200 converts a power supply voltage VDD being provided from the battery 2100 into various levels Vout1˜Vout6 to output them to various driving parts, namely, the application processor 2300, the input/output interface 2400, the RAM 2500, the analog baseband chipset 2600, the display 2700 and the nonvolatile memory 2800, respectively. The power supply circuit 2200 may include by a buck converter which differentiates a feedback voltage to provide the differentiated feedback voltage to a hysteresis comparator, for example, substantially similar to the hysteresis buck converter 100 described in connection with FIG. 1. The power supply circuit 2200 may be provided as a buck converter, for example, substantially similar to the hysteresis buck converter 200 described in connection with FIG. 7, adaptively changing a hysteresis window according to a level of an input or output voltage.

The power supply circuit 2200 applying such technology may operate as a stable DC power supply having a reduced ripple through a high switching frequency. The power supply circuit 2200 may operate as a DC-to-DC converter which operates with a stable switching frequency with respect to a change of an input or output voltage.

A semiconductor device may be mounted using various types of packages such as PoP (package on package), ball grid array (BGA), chip scale package (CSP), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline (SOIC), shrink small outline package (SSOP), thin small outline (TSOP), thin quad flat pack (TQFP), system in package (SIP), multi chip package (MCP), wafer-level fabricated package (WFP) and wafer-level processed stack package (WSP), or the like.

According to some example embodiments of the present inventive concepts, a power supply having a rapid response characteristic, high voltage stability and electric power efficiency, and a control method thereof may be provided.

While the inventive concepts have been particularly shown and described with reference to example embodiments thereof, it will be understood that various changes in form and details may be made therein without departing from the spirit and scope of the following claims.

What is claimed is:

1. A power supply unit converting a DC power supply using an inductor comprising:
a feedback circuit dividing an output voltage being output from a first end of the inductor to convert the output voltage into a first feedback voltage;
a differentiator differentiating the first feedback voltage to convert the first feedback voltage into a second feedback voltage;
a hysteresis comparator comparing a level of the second feedback voltage with a reference voltage band to output a comparison signal; and
a switch performing at least one of pulling up a second end of the inductor with an input voltage or pulling down the second end of the inductor in response to the comparison signal.

2. The power supply unit of claim 1, wherein the differentiator controls a delay such that a phase of the second feedback voltage is synchronized with a phase of a current flowing through the inductor.

3. The power supply unit of claim 2, wherein a waveform of the second feedback voltage is configured to restore a waveform of the current flowing through the inductor.

4. The power supply unit of claim 1, wherein the differentiator comprises:
an operational amplifier receiving the first feedback voltage through a non-inverting terminal;
a capacitor connected between an inverting terminal of the operational amplifier and a ground; and
a resistor connected between an output terminal of the operational amplifier and the inverting terminal of the operational amplifier.

5. The power supply unit of claim 4, wherein at least one of the capacitor and the resistor is variable.

6. The power supply unit of claim 5, wherein a period of pull-up or pull-down of the switch is controlled by controlling the at least one of the capacitor and the resistor.

7. The power supply unit of claim 1, wherein the feedback circuit comprises a first feedback resistor and a second feedback resistor for dividing the output voltage and wherein the first feedback resistor is variable.

8. The power supply unit of claim 1, wherein the reference voltage band corresponds to a linear section of the second feedback voltage.

9. The power supply unit of claim 8, wherein the reference voltage band corresponds to the gap between the minimum value and the maximum value of the second feedback voltage.

10. A hysteresis buck converter comprising:
a feedback circuit dividing an output voltage being output from a first end of an inductor to convert the output voltage into a feedback voltage;
a hysteresis comparator comparing a level of the feedback voltage with a reference voltage band to output a comparison signal;
a switch pulling an input voltage up or pulling the input voltage down to a second end of the inductor with reference to the comparison signal; and
an adaptive hysteresis window controller adaptively controlling a hysteresis window such that the reference voltage band is proportional to the input voltage and is reverse proportional to the output voltage.

11. The hysteresis buck converter of claim 10, wherein the hysteresis window controller comprises:
a hysteresis current generator generating a hysteresis current that is proportional to the input voltage and is reverse proportional to the output voltage; and
a hysteresis voltage generator setting the reference voltage band with reference to the hysteresis current.

12. The hysteresis buck converter of claim 11, wherein the hysteresis current generator comprises a variable resistor having a resistance value corresponding to feedback resistors included in the feedback circuit and wherein the variable resistor is proportional to the level of the output voltage.

13. The hysteresis buck converter of claim 12, wherein the hysteresis current generator generates the hysteresis current having a level that is reverse proportional to the variable resistor and is proportional to the input voltage.

14. The hysteresis buck converter of claim 11, wherein the hysteresis voltage generator generates a first reference voltage and a second reference voltage according to the hysteresis current.

15. A hysteresis buck converter comprising:
an inductor having a first end and a second end;
a feedback circuit converting an output voltage from the first end of the inductor into a first feedback voltage;
a differentiator converting the first feedback voltage into a second feedback voltage; and
a hysteresis comparator comparing a level of the second feedback voltage with a reference voltage band and outputting a comparison signal,
wherein the differentiator controls a delay such that a phase of the second feedback voltage is synchronized with a phase of a current flowing through the inductor.

16. The hysteresis buck converter of claim 15 further comprising a switch, wherein the switch comprises a pull-up switch and a pull-down switch controlling an input voltage of the second end of the inductor in response to the comparison signal.

17. The hysteresis buck converter of claim 16, wherein, when the pull-up switch is activated, a power supply voltage is applied to the second end of the inductor and, when the pull-down switch is activated, the second end of the inductor is grounded.

18. The hysteresis buck converter of claim 15, wherein the differentiator comprises:
an operational amplifier receiving the first feedback voltage through a non-inverting terminal;
a capacitor connected between an inverting terminal of the operational amplifier and a ground; and
a resistor connected between an output terminal of the operational amplifier and the inverting terminal of the operational amplifier.

19. The hysteresis buck converter of claim 18, wherein at least one of the capacitor and the resistor is variable.

20. The hysteresis buck converter of claim 15, wherein the feedback circuit comprises a first feedback resistor and a second feedback resistor for dividing the output voltage and wherein the first feedback resistor is variable.
